(19) United States
(12) Patent Application Publication
(10) Pub. No.: US 2005/0230387 A1
(43) Pub. Date: Oct. 20, 2005

(54) Insulated RF suppressor for industrial magnetrons

(76) Inventor: Michael Regan, Willow Street, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/824,668

(22) Filed: Apr. 14, 2004

(51) Int. Cl. H05B 6/72

(52) U.S. Cl. 219/761

(57) ABSTRACT

A radio-frequency (RF) radiation suppressor component for use with magnetrons that reduces spurious leakage radiation by absorbing RF radiation, that seats a metal ring connector fixture for making electrical contact to the cathode of the magnetron, and that exhibits improved tolerance of higher operating voltages. An insulated RF suppressor component is comprised of an insulating sleeve member and an outer shell cladding layer made of molded composite iron powder/epoxy resin material that absorbs part of the RF radiation and thus acts as an absorber to reduce magnetron radiation leakage. The insulating sleeve end has a ridged groove indentation to seat a metal clamping ring that contacts the magnetron cathode and provides a terminal connection for the cathode voltage bias and filament heating circuit leads. Testing of prototypes indicates significant improvement in permissible operating voltages and comparable RF suppression compared to conventional RF suppressor components currently in use.

### FIELD OF INVENTION

This invention relates to magnetron microwave vacuum tube devices used to generate radio-frequency (RF) electromagnetic energy, and which find applications in microwave heating. More particularly, the invention relates to components used in magnetrons to suppress spurious radio-frequency energy transfer and to provide electrical insulation of electrodes; and further relates to designs and methods of construction to reduce failure rates of these components.

### BACKGROUND

The magnetron is a well known vacuum tube electronic device used to generate radio-frequency (RF) electromagnetic energy. The magnetron was invented by Hull in 1921, and came into rapid development during the Second World War as a high-power microwave generator for radar transmitter applications. Currently, magnetrons are in widespread use for microwave cooking, thawing, tempering, drying of materials such as textiles and lumber, and other industrial and laboratory heating processes such as waste remediation and chemical vapor deposition.

Magnetrons are made up of machined or formed metal parts, some of which function as electrodes. The electrodes are appropriately separated by electrically insulating elements, and arranged and sealed to form an evacuated enclosure. The electrodes include a heated cathode that emits electrons, and an anode that is shaped to form the essential resonant cavities needed to generate high-frequency (several hundred megahertz to several gigahertz) electromagnetic radiation. Referring to FIG. 1, the magnetron has a basically cylindrical form with a cathode rod 102 oriented along the axis A-A, surrounded by an annular anode 104. The intervening space 106 between the cathode and anode forms part of the resonant cavity, or more accurately, a series of coupled resonant cavities. The interior space of the magnetron is evacuated to a sub-atmospheric pressure and sealed. The cathode is electrically heated by a filament circuit to thermionically emit electrons. A dc voltage is imposed between the cathode and anode, with the cathode potential negative with respect to the anode. The applied voltage establishes a static radial electric field between the cathode and anode that sustains the thermionic emission current of electrons in the vacuum gap separating the cathode and anode. A static axial magnetic field, created by permanent magnet or, more commonly by an electromagnet, is oriented parallel to the axis A-A. Thus, the static electric and magnetic fields are mutually perpendicular to each other and for this reason magnetrons are referred to as crossed-field microwave tubes. Within the geometric constraints of the cavity formed by the anode and cathode, and under proper biasing and operating conditions, the thermionic electrons execute a continuous cycloidal motion around the cathode. Some of the energy of the thermionic electrons is transferred to electromagnetic energy at a resonant frequency characteristic of the magnetron and its bias point. A fraction of this electromagnetic radiation exits the magnetron cavities, through antennae connected to the cavities, and is coupled into a waveguide. The radiation launched into the waveguide constitutes the useable microwave or RF output power for heating, excitation, or signaling.

Ideally, all of the electromagnetic energy generated by the magnetron would be coupled into a waveguide or antenna, or else focused as a directed, collimated beam. However, it is practically inevitable that some of the radiation generated by the magnetron will be transmitted to surrounding areas of the magnetron where it is neither utilized nor wanted. It has proven useful, and often necessary, to reduce this spurious electromagnetic radiation that permeates into the surroundings of an operating magnetron. This leakage radiation can interfere with electronics in the vicinity of the magnetron. Adequate suppression of leakage radiation can be achieved by a device termed an RF suppressor. The RF suppressor component is an approximately toroidal-shaped element, resembling a collar or split lug, made of a material that absorbs radio-frequency electromagnetic energy. The RF suppressor is mounted on the magnetron and absorbs radiant energy, thus avoiding or lessening many of the problems associated with electromagnetic interference from the magnetron. According to the design of many typical magnetrons, the RF suppressor is most effective at reducing problematic leakage radiation when it partially shrouds the magnetron tube in close proximity to the cathode connector for the cathode voltage bias. On account of this, it is convenient and effective to make the RF suppressor component integral to the fixture used to make electrical connections to the cathode. In the current practice of utilizing RF suppressors in magnetrons, one side of the RF suppressor collar is machined to accommodate the cathode voltage supply connecter fixture that clamps the cathode and provides a terminal post for electrical leads. Two threaded holes receive screws with washers to hold the RF suppressor to the cathode connector fixture. The cathode connector is also used to tie a lead of the filament heater circuit to the cathode. Thus, the combined component, comprising the RF suppressor mated to the cathode connector fixture, serves multiple functions.

Many applications of magnetrons benefit from increased power capacity, and there is incentive to increase the radio-frequency electromagnetic power that can be produced by magnetrons. Increased power levels imply higher operating voltages, specifically a negative voltage, of higher than normal magnitude, is applied to the cathode 102. The relationship between magnetic field strength, cathode bias voltage, filament current, and magnetron geometry needed to establish a stable operating point of a specified RF output power and frequency is complex. However, the present design trend is that high output power requires a higher magnitude cathode voltage bias between the cathode and the grounded anode. As a consequence of greater operating power levels, more stringent demands are imposed on the ability of the magnetron design and materials to withstand relatively high electric fields. The total electric field is the sum effect of the static electric field due to the dc voltage bias applied between the cathode and system ground, and the time-varying RF electric fields generated in the resonant cavity structure of the magnetron related to the cycloidal motion of the electrons. The grounded elements of the magnetron include the anode, coolant tubes, the enclosure housing, external magnet pole piece, and mounting brackets. The exact spatial distribution of this resultant electric field is difficult to predict, but it is evident, both intuitively and from experiment, that the sites that bear the largest magnitudes of the electric field, and hence are the most problematic with regard to high-voltage associated failures, occur near the terminal where the high-negative-voltage bias is applied to the cathode. As evidence, it is noted that as the output power levels of some industrial magnetrons have increased from 30 kilowatts to 80 kilowatts in recent years, there has been a significant increase in the failure rate of the RF suppressor component of magnetrons due to the increased power levels and associated higher cathode bias voltages. In many cases, the RF suppressor has proven to be the magnetron component that is most susceptible to high voltage breakdown effects, and is implicated as the dominant cause of failure in magnetrons operated at high power levels.

The present inventor has analyzed the failure mechanisms of RF suppressors and has identified the specific sites of magnetron RF suppressor failure and the specific nature of the failure. As a result of those investigations, a new insulated RF suppressor which is adapted to high-voltage operation has been developed. The invention disclosed herein provides an improved RF suppressor, the design of which ameliorates the main causes of component failure, i.e., electrical arcing. Laboratory testing of magnetrons utilizing these insulated RF suppressors has indicated that significantly reduced failure rates can be anticipated.

An example of a commercial magnetron used for industrial heating, such as in food processing, is shown in FIGS. 2a, 2b, 2c, and 2d. With reference to FIG. 2b, the magnetron 200 has a generally cylindrical geometry with a cathode and an annular anode aligned along a main axis B-B of the device. The magnetron cavity, a typical arrangement of which is illustrated shown in FIG. 1, encompasses a midsection of the device denoted as 202 in FIG. 2b. A ring-shaped fixture 204 provides a contact to the cathode and a terminal to connect the cathode voltage bias lead and one lead of the filament heating circuit. This fixture is seated in the RF suppressor component which is the subject of the present invention. Another fixture 206 provides a terminal for connecting a second lead of the filament heating circuit. Most of the RF radiation generated by the magnetron exits the cavity through a ceramic dome end piece 208 which is effectively transparent to the RF radiation. Tube ducts 210 are provided as a coolant water loop to cool the anode in order to dissipate the heating caused by the impact of energetic thermionic electrons on the anode.

FIG. 3 shows a typical deployment of a magnetron in an industrial heating application. A magnetron 302 is coupled to a waveguide 304 by inserting the output ceramic dome 306 of the magnetron into the waveguide. An electromagnet 308 surrounds the cavity 309 and produces a magnetic field aligned along axis C-C. A molded filament-cathode connector piece 310 is mated with a cathode connector terminal fixture and can be constructed to function as an RF suppressor. The RF suppressor component is the subject of the present invention. A lead of the cathode filament heating circuit is also connected to filament-cathode connector piece 310, and another lead of the filament heating circuit connects to filament connector 312 which also contacts the cathode. Without an RF suppressor component, there would otherwise be a substantial leakage of RF radiation, illustrated by arrows signified as 314, into the upper surroundings of the operating magnetron. There are two distinct causes of this radiation leakage. There is RF leakage due to electric currents that are induced in and carried by the central axial conductive path that constitutes the cathode and cathode heater elements and which extend up through the cavity into axial sections with the filament-cathode connector 310 and filament connector 312. These stray currents induce RF fields in the upper portion of the magnetron tube and are the source of much of the spurious radiation leakage. There is also RF radiation leakage due to electromagnetic radiation generated in the magnetron resonant cavity that emanates through the ceramic insulator components that are situated between the cathode connector pieces and grounded anode. A choke mechanism attenuates, but does not completely eliminate, these effects. Thus, there arises a need for an RF attenuator or suppressor to reduce this leakage radiation from the upper sections of the magnetron.

A magnetic pole piece 316 disposed around the upper portion of the magnetron 302 serves as an electrical connection to ground. An RF gasket 318 disposed around the lower portion of the magnetron adjacent the waveguide 304 seals the base of the magnetron to the waveguide. An air inlet 320 for the tube output ceramic dome 306 is provided on the bottom of the waveguide to provide cooling air to the ceramic dome. Most of the generated RF radiation (arrow 322) is directed down the waveguide, away from the magnetron in the known manner.

FIG. 4 shows the supporting circuitry for operating the magnetron tube 402 with cathode 404 and grounded anode 406. As already mentioned, there are two connections to the cathode. The first is implemented by the filament-cathode connector 408 which is comprised of the cathode connection fixture mated to the molded RF suppressor, and which is the subject of the present invention. The second is the filament connector 410 which is in contact with the cathode, but in a higher position, with respect to the magnetron cavity, along the axis of the magnetron. The filament control circuit 412, through a step-down transformer 414, imposes a voltage V_{F} across the cathode between 408 and 410. This voltage controls the heating of the cathode 404 needed to sustain the thermionic current. Typically, V_{F} is in the range of 5 to 10 volts. The cathode bias V_{K} (negative polarity with respect to ground) is provided by a three-phase delta-delta step-up transformer 416, a diode rectifying circuit 418, and an electronic crow-bar voltage regulating circuit 420. The magnitude of the cathode voltage bias V_{K} can range from 15 to more than 30 kilovolts. An electromagnet 422 creates the static axial magnetic field of the magnetron and is energized by a controlled dc power supply 424. Commonly, an anode current sampling circuit, such as 426, controls the electromagnet and filament power. An undercurrent relay 428 and an overcurrent relay 430 can terminate the cathode bias voltage through circuit breakers 432 in the event of some malfunction. This associated circuitry, i.e., the controlled power supplies, sampling circuits, current protection devices, RF relays, arc detectors and the like, is susceptible to interference associated with RF radiation leakage from the magnetron. One purpose of the RF suppressor component is to reduce this potentially problematic interference effect.

The known RF suppressors are formed in the shape of an annular collar piece. A molded RF suppressor piece is shown in FIG. 5. A ridged groove 502 is machined along the top edge, along with two openings 504, so that a annular metal cathode connector fixture may be seated in the groove as shown in the photograph of FIG. 6, which portrays the molded RF suppressor 602 and a brass cathode terminal fixture 604. Referring again to FIG. 5, two screw holes 506 are machined in the molded RF suppressor so that the brass terminal fixture can be fastened to the molded RF suppressor with screws and washers 606, as shown in FIG. 6. The cathode terminal fixture clamps the cylindrical cathode by tightening nut and bolt 608 to make a reliable electrical contact. Again referring to FIG. 6, the cathode bias and filament circuit leads are connected to terminal post 610.

The known RF suppressor is made of a molded epoxy binder material having iron particles suspended therein. This material is chosen primarily for its excellent RF radiation absorbing properties. There are a number of commercially available RF and microwave absorbing materials, such as, for example, those supplied by the Emerson & Cuming Co. (Randolph, M A) under the trademark ECCOSORB®, that are suitable for the fabrication of RF suppressor components. Material selection can be used to optimize these absorbers for a particular application. The known materials can be molded into various shapes and sizes. After molding the basic shape of the RF suppressor component, the top end is machined with a groove and other features to accommodate mating with the cathode voltage supply connector fixture of the magnetron.

The effectiveness of an RF suppressor can be quantified in a number of ways. A suppression ratio can be defined as

$$Suppression = 10 \cdot {log}_{10} [ \frac{{P}_{leakage detected}}{{P}_{coupled}} ]$$

and measured in decibels (dB). In the above equation, P_{leakage} detected is the RF power detected at some reference location with respect to the magnetron, and P_{coupled} is the RF power coupled through the waveguide to a load. The suppression ratio is somewhat arbitrary since it depends on the detector reference location and the magnetron operating conditions. Nevertheless, the suppression ratio can be used to compare various RF suppressors: the utility of a particular RF suppressor can be evaluated by measuring the suppression ratio with and without the suppressor installed under identical operating conditions. The standard RF suppressor provides about −3 dB additional attenuation compared to magnetron operation with no RF suppressor installed.

The identification of common failure modes of a magnetron, i.e., the locations and mechanisms of phenomena that result in sub-optimal performance, malfunction, or damage to the device, is necessary in order to design a better magnetron. The present invention is concerned with failure modes associated with the effects of high electric fields on the RF suppressor. Virtually all materials exhibit some type of failure or breakdown when immersed in an electric field of sufficiently high field strength. The failure phenomena, in some cases classified as dielectric breakdown, often involve a combination of arcing and avalanche effects resulting in irreversible changes in materials properties, and invariably rendering the material unsuitable for continued use. As a result of this potential for permanent damage, materials are rated according to a maximum tolerable electric field strength. Since the electric field is due mainly to voltage differences imposed across the material, this maximum field strength criteria can also be expressed in terms of a voltage-hold off capability. For magnetrons, the voltage-hold off capability implies a maximum cathode voltage bias that should not be exceeded in order to safeguard the magnetron. Failure and damage due to high electric fields can be prevented by either selecting materials with higher voltage-hold off capability, or by employing designs which avoid the occurrence of excessive electric fields in parts of the device that are vulnerable to electric field-induced break down. In order to design improved RF suppressors and assess their potential, the cause and mechanism of field-induced failure must be identified and analyzed.

In the context of magnetron RF suppressors, the susceptibility to electric field-induced damage has been investigated by the present inventor and prominent failure mechanisms have been identified. In the normal course of operation of a magnetron, a high voltage is imposed between the metal cathode terminal and other electrically grounded metal surfaces, including the anode, casing, cooling tubes, etc. This dc cathode voltage bias sustains the thermionic electron emission current from the cathode to the anode that is necessary for operation of the magnetron. The resulting static electric field distribution depends on the geometric details of the magnetron including the boundary conditions imposed by metal surfaces, and the relative dielectric constants of the component materials. The static electric field is supplemented by a radio-frequency electric field caused by the cycloid motion of electrons in the magnetron cavity. Further, when the magnetron is turned on, there is a transient electric field due to overshoot of the power supply used to bias the cathode. The resultant electric field distribution from all of these contributions can be complex, but it is generally true that regions of comparatively high electric field strength occur in the vicinity of the cathode connection to its voltage bias supply. These regions of concentrated electric field strength, should they occur within or near materials with relatively low breakdown-voltage characteristics, are susceptible to damage. The RF suppressor component is one such component that is both prone to high electric field breakdown effects and deployed at a location where the electric field strength is expected to be relatively high.

Once voltage breakdown has been initiated in the composite RF suppressor material, it contributes to an avalanche effect in which a small electric arc travels through the suppressor, and a plasma is formed in the air surrounding the suppressor. The arc enlarges, ionizing the air, and forms a conducting channel that extends from the cathode terminal on the magnetron to a grounded surface in the vicinity of the suppressor that may include the external magnet pole piece, coolant water tubes, or some other grounded structure in the RF shield cabinet where the magnetron is stationed. Although the arc is eventually extinguished when the over-current protection device on the cathode power supply shuts the cathode voltage supply off, significant damage will still have occurred to the suppressor material. Failed suppressors are frequently charred or otherwise burned in an area where the suppressor contacts the high-voltage cathode supply terminal, or else along the inner surface of the suppressor annulus in the vicinity of the magnetron cathode contact. The damage to the RF suppressor will also typically include a punch through characterized by a perforation of the RF suppressor along the radial direction. A hole may be completely burned through the RF suppressor from its inner surface to its outer surface, or there can be a partial punch-through hole where material is visibly ablated mostly from the outer surface of the RF suppressor.

The damage to the RF suppressor due to cathode supply arcing is almost always irreversible. At minimum, the damage almost always requires replacement of the RF suppressor part for continued operation of the magnetron. Moreover, the magnetron itself is often damaged. The choke ceramic often sustains severe arcing characterized by a blackened area of several square centimeters in extent. The ceramic-to-metal seal on the magnetron choke is often damaged to a degree that results in loss of magnetron tube vacuum. When a vacuum tube loses its vacuum seal, it is no longer viable and must be rebuilt at considerable cost. The economic costs associated with RF suppressor component failure has made the development of improved industrial magnetron RF suppressors, able to sustain higher electric fields without damage, a pressing priority and motivate the present invention.

### SUMMARY OF THE INVENTION

The present invention is directed to overcoming the problems associated with the known RF suppressors by use of an insulated RF suppressor that provides significant improvement with regard to tolerating higher cathode bias voltages. The insulated RF suppressor according to the present invention reduces magnetron failure rates and permits safer and more reliable operation at high microwave power levels.

The insulated RF suppressor according to the present invention is formed as a two-layered annular structure including an inner insulating sleeve and a coaxial outer RF absorbing shell. The inner sleeve of the RF suppressor is fabricated, by for example, machining or molding, from an electrical insulating material such as polytetrafluoroethylene (PTFE) and has a thickness of approximately 100 mils (about 2.5 millimeters). The outer shell is molded from the same or similar RF-absorbing material used in conventional magnetron RF suppressors. The PTFE sleeve provides a high degree of resistance to electrical breakdown at precisely the sites of the RF suppressor that are most susceptible to the adverse effects of high operating voltages. The use of the insulating inner sleeve realizes voltage break down characteristics that are significantly superior to those exhibited by conventional RF suppressors. At the same time, the molded outer cladding layer shell provides an RF absorbing function nearly equivalent to that attained in conventional RF suppressors that have no inner insulating sleeve. Thus, RF suppression is not unduly sacrificed in order to gain higher operating voltages.

The insulating inner sleeve may be fabricated, by for example, machining or molding, with a groove to seat the metal ring fixture that clamps the cathode for electrical contact and present a terminal post for can connecting the cathode voltage bias circuit and one lead of the filament circuit that heats the cathode. The screws, washers, and threaded holes used to fasten the cathode contact fixture to the RF suppressor are replaced with tabs in the insulating sleeve that hold the seated fixture in a groove formed on the edge of the RF suppressor insulated sleeve. The elimination of machined surfaces and the associated metal hardware is expected to provide further improvements in the voltage-hold off capability of an RF suppressor. Further, machined surfaces that absorb moisture and sharp edges that promote acing are eliminated in the RF absorber shell of the insulated RF suppressor.

The insulated RF suppressor according to the present invention is shaped and configured to be completely compatible with any arrangement for an industrial magnetron, and thus can be immediately incorporated into the manufacture of new magnetrons. The insulated RF suppressor can also be used to replace damaged conventional RF suppressors, or serve as a substitute component to retrofit magnetrons in the field with insulated RF suppressors as part of a preventative maintenance program.

Electrical testing of insulated RF suppressors indicates higher breakdown voltages are achieved with the insulated RF suppressor compared to conventional RF suppressors. In one series of tests, the insulated RF suppressor demonstrated a 30% higher voltage needed to initiate arcing, compared to a commercially-available, currently-used RF suppressor. Measurement of RF suppression performance showed that the insulated RF suppressor performed comparably to, or in some cases even outperformed, several commercial RF suppressors currently in use. Further, magnetrons using insulated RF suppressors were operated for prolonged, failure-free periods at RF power levels of 80 kilowatts. By contrast, some experience with the same magnetrons using conventional (non-insulated) RF suppressors under similar operating conditions showed a marked higher rate of failure.

### BRIEF DESCRIPTION OF THE DRAWINGS

FIG. 1 is a schematic view of a known magnetron tube;

FIG. 2A is a top plan of a known industrial magnetron;

FIG. 2B is a side elevation view of the magnetron shown in FIG. 2A;

FIG. 2C is a bottom plan view of the magnetron shown in FIG. 2B;

FIG. 2D is a photograph of an actual magnetron of the type shown in FIGS. 2A-2C;

FIG. 3 is a side elevation view of an industrial magnetron as typically installed with a wave guide;

FIG. 4 is a schematic diagram of the known typical supporting circuitry for a magnetron tube;

FIG. 5 is a perspective view of a known RF suppressor component;

FIG. 6 is a photograph of an actual RF suppressor of the type shown in FIG. 5 with a standard brass fixture for clamping to a magnetron cathode;

FIG. 7A is a perspective view of an insulated RF suppressor according to the present invention;

FIG. 7B is a photograph of a prototype of the insulated RF suppressor shown in FIG. 7A;

FIG. 8A is a top plan view of the inner insulating sleeve of the insulated RF suppressor shown in FIGS. 7A and 7B;

FIG. 8B is a side elevation view in cross section of the insulating inner sleeve shown in FIG. 8A, as viewed along line 8B-8B therein;

FIG. 8C is a side elevation view of the insulating inner sleeve shown in FIG. 8A;

FIG. 9 is a photograph of an insulated RF suppressor according to the present invention assembled with a standard brass fixture for clamping to a magnetron cathode;

FIG. 10 is a photograph of an assembly of the insulated RF suppressor and an industrial magnetron;

FIG. 11 is a schematic diagram of a high-voltage test set up used for testing RF suppressors;

FIG. 12 is a graph of RF attenuation vs. magnetron output power for several different types of RF suppressor units;

FIG. 13 is a perspective view of an alternate embodiment of an insulated RF suppressor according to the present invention;

FIG. 14A is a top plan view of an alternate embodiment of a cathode connection fixture used with an insulated RF suppressor according to the present invention;

FIG. 14B is a first side elevation view of the cathode connection fixture shown in FIG. 14A; and

FIG. 14D is second side elevation view of the cathode connection fixture shown in FIG. 14A.

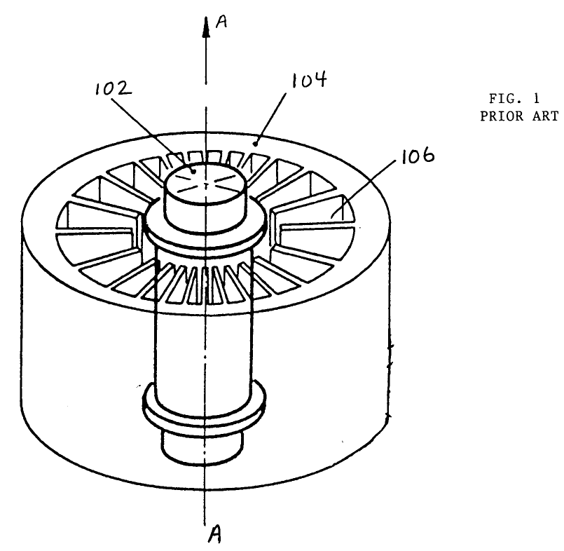

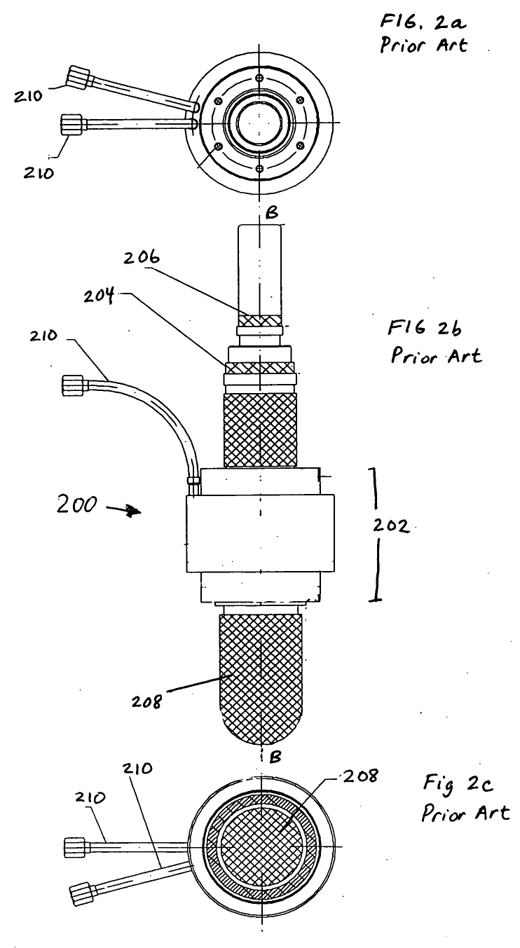

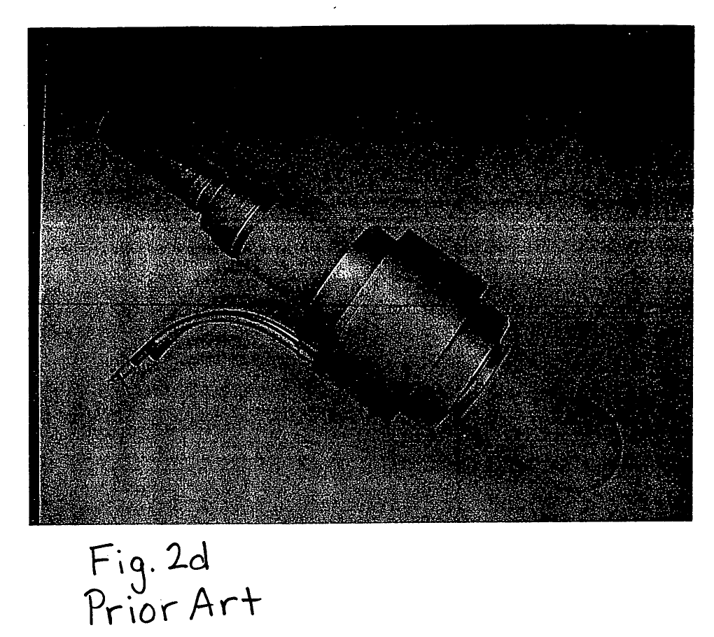

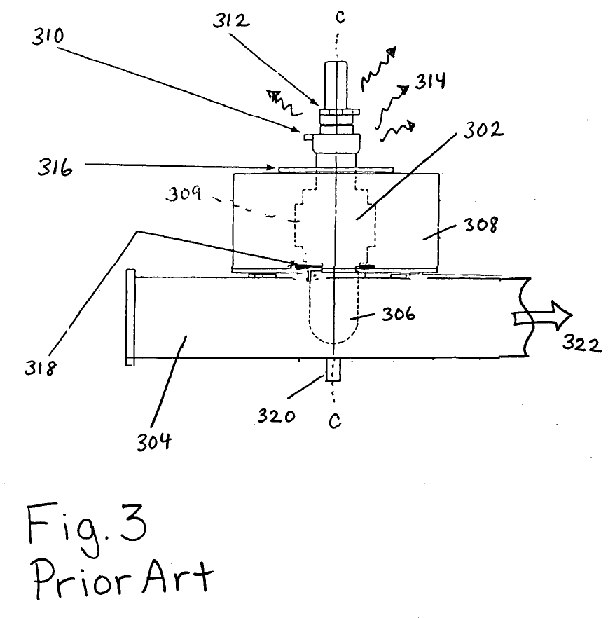

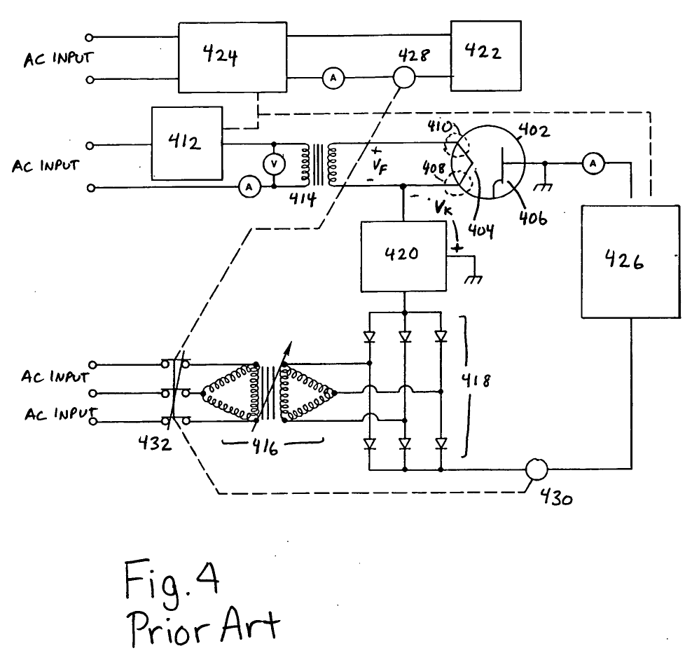

### DETAILED DESCRIPTION OF THE INVENTION

A new type of RF suppressor is described herein. By fabricating the RF suppressor component from two functionally distinct materials, the performance of the RF suppressor, particularly with respect to its high-voltage tolerance, can be enhanced compared to that of RF suppressors made from only one type of material. The present invention is an insulated RF suppressor that incorporates an inner sleeve of highly electrically resistive material that can withstand the application of very high electric fields. The insulated RF suppressor component is fabricated as a bilayer composite of two parts: an insulating member shaped from a polymer material such as PTFE, and an RF-absorbing member comprised of a suspension of iron particles in an epoxy resin and shaped by using the insulating member as part of a form to mold the RF-absorbing material. The resulting RF-suppressor is then a single-piece comprised of an annular-shaped insulating polymer sleeve with a molded RF-absorbing shell formed as a cladding layer on the outer surface of the insulating sleeve member.

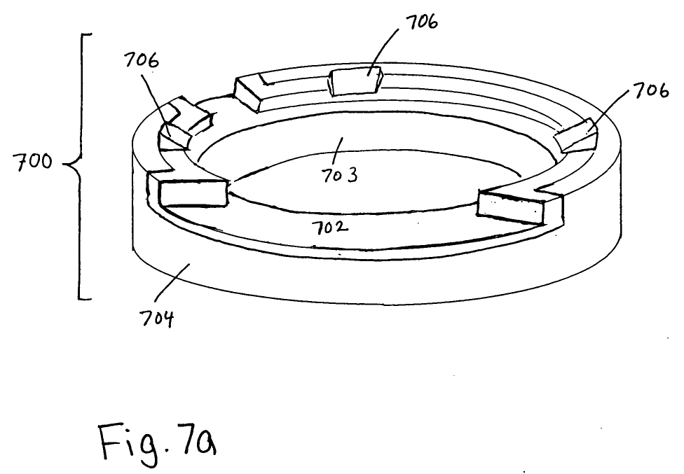

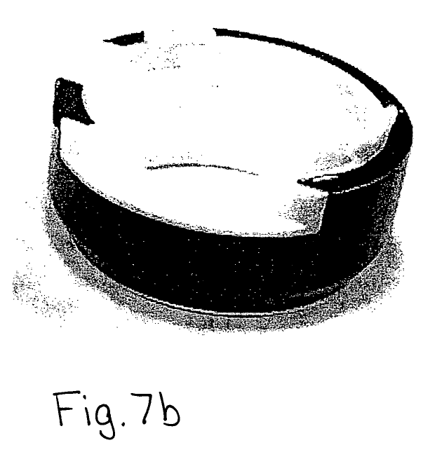

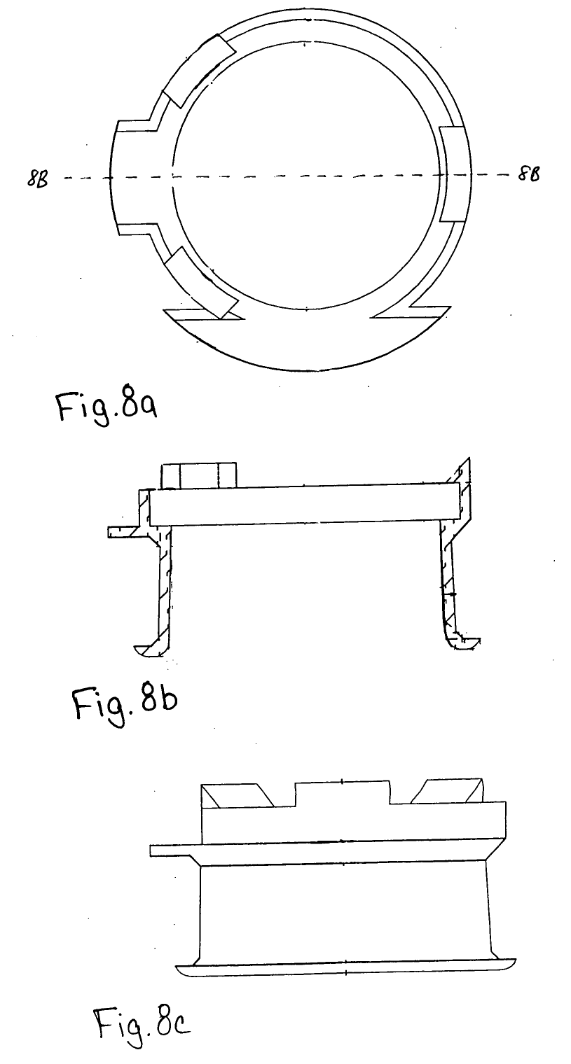

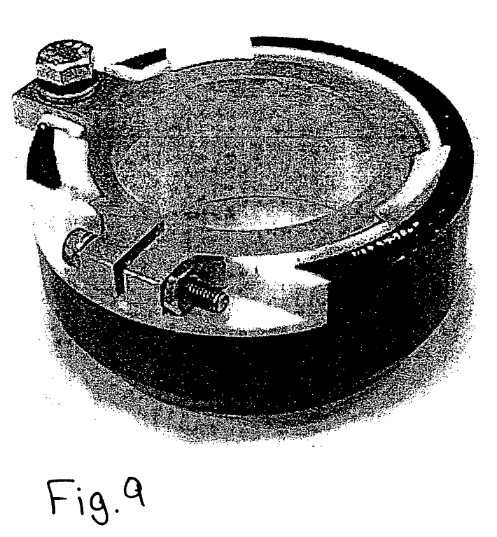

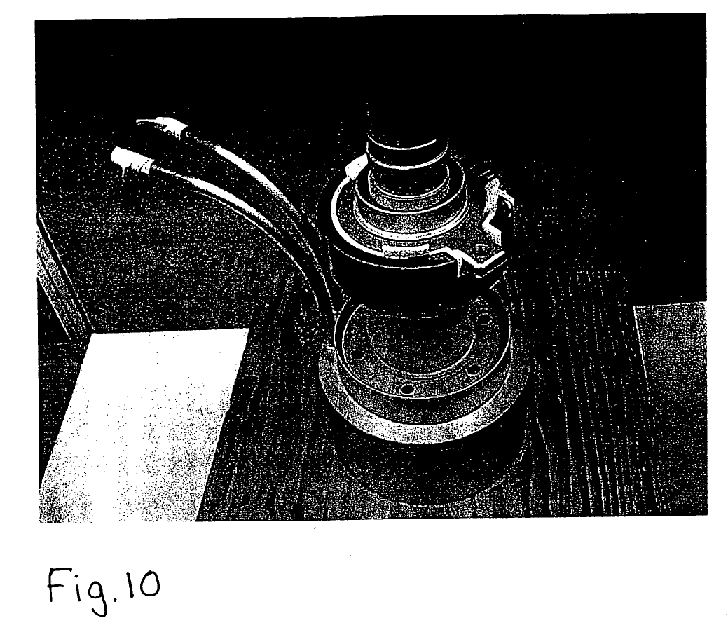

Referring now to FIGS. 7A and 7B, there is shown an insulated RF suppressor 700 according to the present invention. The suppressor 700 includes an inner sleeve 702 and an outer shell 704 surrounding the inner sleeve. The inner sleeve 702 is preferably made from an insulating polymer such as PTFE, and the outer shell 704 is preferably made from a molded RF absorbing material.

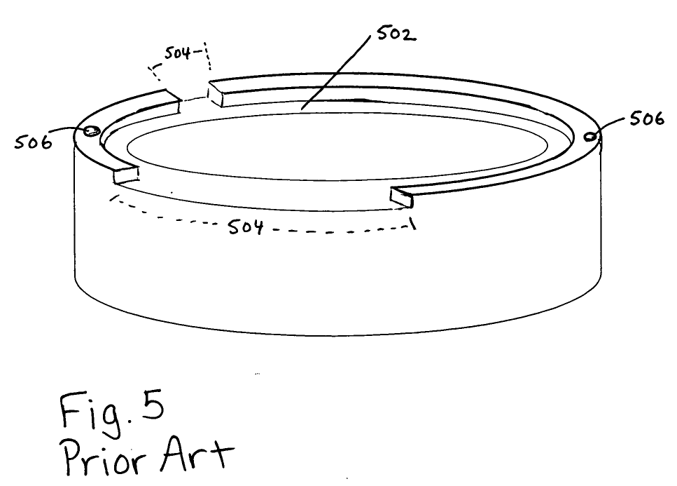

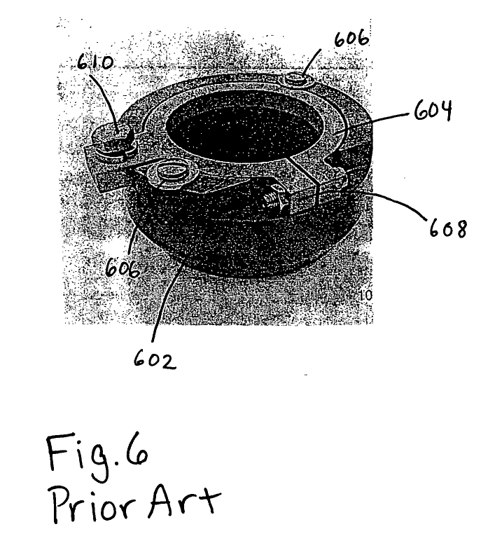

The insulated RF suppressor performs basically the same function as the conventional RF suppressor described above in connection with FIG. 5, but is structurally distinguished in several aspects. As shown in FIG. 7A, the inner surface 703 of the inner sleeve 702 of the RF suppressor that contacts the cathode is made from PTFE. With that arrangement, the RF absorbing outer shell 704 is prevented from directly contacting the magnetron cathode. In the preferred arrangement, there is an at-least-100-mils-(2.5 millimeters) thickness of the insulating inner sleeve that separates the cathode surface from the RF absorbing material. All the machined surfaces are restricted to the insulating inner sleeve 702. The outer shell 704 preferably has no machined surfaces. The groove that seats the cathode connector fixture is made in the insulating inner sleeve 702 so that the metal clamping fixture (not shown in FIG. 7A) does not directly contact the outer shell 704 of the RF absorbing material. Further, the insulated RF suppressor has tabs 706 formed thereon which hold the clamping fixture. In this regard, the tabs 706 replace the screws and washers used in the known RF suppressor. It will be appreciated that the sharp edges of the RF absorbing material, that are prone to arcing are effectively eliminated with the insulated RF suppressor according to the present invention. Further, the elimination of metal parts, such as screws and washers, as afforded by the use of tabs as described above, also eliminates a cause of arcing and voltage breakdown.

An insulating RF suppressor according to the present invention is preferably made as follows. The insulating sleeve is machined or molded from PTFE or other suitable polymer. A mold is made up of two cylinders of differing diameters. The inner insulating sleeve is slipped snugly over the outside of the smaller-diameter cylinder. The smaller-diameter cylinder with insulating sleeve is then placed co-axially inside the larger-diameter cylinder. The RF suppressor material, such as ECCOSORB®-CR, comprising two components, an iron-powder-filled resin and an activator/hardener, is mixed and filled into the annular spaces between the two cylinders and the insulating sleeve. The molded mixture is then cured in an oven according to the process specifications provided by the manufacturer of the RF absorbing material.

An important difference between the known RF suppressor and the insulated RF suppressor according to the present invention is that in the insulated RF suppressor, the machined surfaces used to form the groove for the metal cathode connector fixture are restricted to the insulating sleeve, whereas in the conventional RF suppressor, the molded RF absorber material is machined. In fact, in the insulated RF suppressor, there is no machining of the molded RF absorber material. This aspect has important significance for the high-voltage tolerance of the insulated RF suppressor relative to the conventional RF suppressor because it is believed that machining of the molded RF absorber material causes suspended iron particles to be exposed at the machined surfaces. Such exposed metal particles act as point radiators or can concentrate the electric field and promote arcing effects. Thus, the elimination of machined surfaces, as well as the general avoidance of any sharp geometric features, in the molded RF absorber material contributes to the improved high-voltage tolerance of the insulated RF suppressor. Further, machined surfaces of the ECCOSORB® materials are believed to have a higher propensity to absorb moisture which degrades the electrical performance of the material such as its RF radiation absorption characteristics and voltage-holdoff capabilities.

Several tests were conducted to evaluate both the ability of an insulated RF suppressor according to the present invention in attenuating RF energy in a magnetron and in reducing failure associated with high-voltage, high-power operation of a magnetron. The tests were performed with a working example of the insulated RF suppressor according to the present invention.

Arcing Test

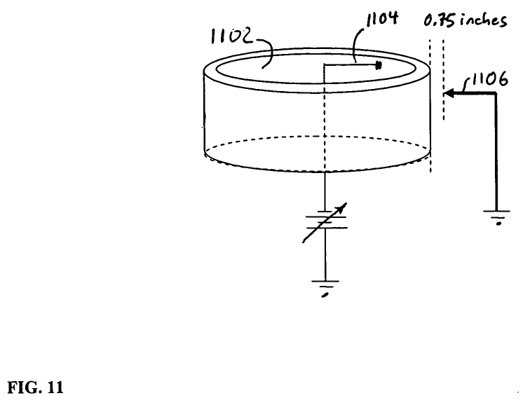

Using a high electric potential test, the arcing properties of a working example of the insulated RF suppressor according to the present invention were compared to those of a non-insulated RF suppressor of the type currently used in commercial industrial magnetrons. In this particular high potential test, as depicted in FIG. 11, a negative-polarity voltage probe 1104 is placed in intimate contact with the inside surface 1102 of the RF suppressor under test. An electrically-grounded contact 1106 having a sharp point is disposed in close proximity, but without contact, to the outer sleeve of the RF suppressor, leaving an approximately 0.75-inch spark gap. The voltage applied to the voltage probe 1104 is then increased until arcing is observed in the spark gap. The potential needed to induce breakdown and arcing, as evidenced by the spark between the sharp electrode and RF suppressor surface, indicates the maximum hold off voltage.

In the comparative testing, the non-insulated RF suppressor was observed to arc at 24 kilovolts applied potential whereas the insulated RF suppressor was observed to arc at 30 kilovolts applied potential. Therefore, the insulated RF suppressor according to the present invention provided a 6 kilovolt improvement in the hold-off voltage under the test conditions specified.

High-Voltage Test on a Magnetron

An insulated RF suppressor according to the present invention was installed on a magnetron and the cathode bias voltage was snapped from 0 volts to −35 kilovolts in 2 seconds. This test was repeated five times with no failure of the RF suppressor. The leakage current measured through the RF suppressor was 80 microamps, well below the normal allowable leakage current of 2 milliamps.

RF Suppression Test

The insulated RF suppressor according to the present invention was evaluated for RF radiation suppression effectiveness in a magnetron unit using a Burle Model S94604F magnetron under operating conditions typical of its customary use in service. A magnetron having no RF suppressor was tested to provide a baseline reference for RF suppressor performance. The comparative setups included a magnetron having a standard (i.e., non-insulated) RF suppressor made by Burle Industries (part CR116VAC-2) and a magnetron using a standard (non-insulated) RF suppressor of the type used in commercial industrial magnetrons made by a U.S. manufacturer of microwave heating equipment.

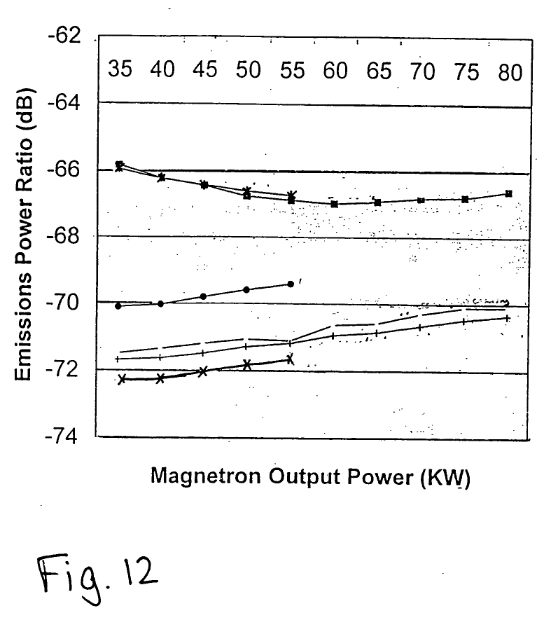

The RF suppression is assessed by comparing the amount of leakage RF power measured relative to that measured when no RF suppressor is used. The suppression or emission power ratio is a figure of merit for comparing the efficacy of RF suppressors. The RF suppression ratio is defined as the leakage power emanating from the magnetron and measured by an RF power meter with its receiving antenna situated at a defined reference point with respect to the magnetron to the RF powered delivered to a load, as measured by the change in temperature of a water heating load that terminates a waveguide coupled to the magnetron. FIG. 12 shows plots of emission power ratio (dB) for several RF suppressors as a function of RF output power (KW). The lower the emission power ratio, the more effective the RF suppression. The plot legend is according to:
▪'s: no RF suppressor
−−: insulated RF suppressor with no HUMISEAL® coating
x's: standard Burle RF suppressor (part CR116VAC-2)
*'s: no RF suppressor
●'s: commercial RF suppressor
+'s: RF insulated suppressor coated with HUMISEAL® coating

The insulated RF suppressor provided about 4 to 6 dB of attenuation, with respect to a baseline case of a magnetron operating with no suppressor, and also outperformed a commercial RF suppressor used by at least one U.S. magnetron microwave heating manufacturer. Further, the insulated suppressor attenuation was almost comparable to that provided by the standard Burle CR116VAC-2 RF suppressor. Therefore, it is evident that the insulated RF suppressor design has not greatly sacrificed RF attenuation capability in order to achieve improved high-voltage resistance. The insulated RF suppressor was tested with and without a HUMISEAL® coating; with the coating provided a small but perceptible improvement in RF attenuation. This observation is in accordance with the expectation that such coatings would not significantly affect magnetron operating performance with respect to RF absorption. The purpose of such coatings is instead to merely provide additional resistance to moisture absorption and thus help reduce certain degradation phenomena associated with moisture.

Life Testing

Beginning-of-Life testing was initiated for the example of the insulated RF suppressor according to the present invention with the following cycle sequence: (1) high-voltage cathode bias OFF, (2) high-voltage cathode bias ON, (3) snap on RF power from 0 to 75 kilowatts, (4) snap RF power OFF, (5) high-voltage cathode bias OFF. This cycle was repeated ten times in a typical industrial microwave heating unit where the insulated RF suppressor was installed on the magnetron. No circuit breaker tripping nor arcs were evident at any time. In a further test, an industrial heating magnetron employed an insulated RF suppressor in continued use for several hundred hours without failure.

Alternative Embodiment of the Insulated RF Suppressor and Cathode Connection Fixture

Alternative embodiments of the insulated RF suppressor that conform to and improve upon features prescribed by the basic design described hereinabove are possible. Such alternate embodiments of the invention may include additional insulating coatings, shrink tubing or shrink wrapping, or other types of encapsulants to provide additional insulating protection and/or moisture barriers. An RF suppressor made of two machined insulating members with an intervening layer of RF absorbing material is one possible alternative embodiment of the present invention.

Referring now to FIG. 13 there is shown an insulated RF suppressor 1300 having an inner insulating sleeve 1302, outer insulating sleeve 1304, and an intervening layer 1306 of molded RF absorbing material. It will be understood that alterations to the geometry of the RF suppressor members, and substitution of materials that perform the same essential function although not identical to those disclosed herein, are considered to be within the scope and spirit of the present invention.

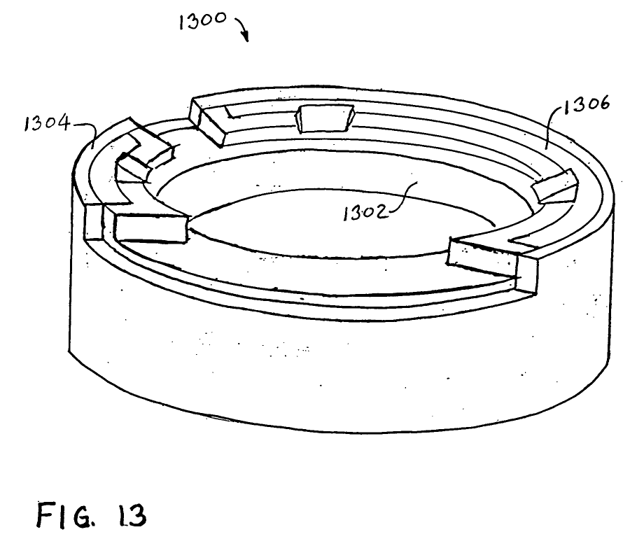

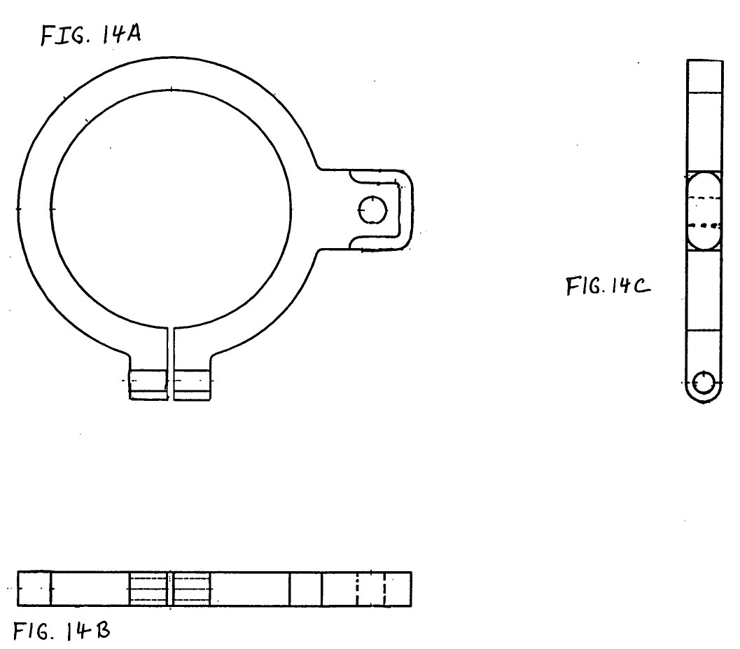

Further, the design of the insulated RF suppressor according to the present invention provides an opportunity to improve the design of the metal cathode connector fixture that mates the RF suppressor to the magnetron cathode. The connector fixture shown in FIGS. 14A-14C is fabricated without the sharp edges and corners that are present in the known designs and which are suspected of facilitating arcing during high voltage operation in service.

1. A radio frequency radiation suppressor for a magnetron, comprising
a) an inner sleeve member made of an electrical insulating material, and
b) an outer shell assembled to said inner sleeve member, said outer shell member being made of a material that absorbs radio-frequency radiation.

2. The radio frequency radiation suppressor set forth in claim 1 comprising a metallic connector attached to the inner sleeve member for contacting the magnetron.

3. The radio frequency radiation suppressor of claim 1 wherein the electrical insulating material is a machinable polymer.

4. The radio frequency radiation suppressor of claim 3 wherein the electrical insulating material is polytetrafluoroethylene polymer.

5. The radio frequency radiation suppressor of claim 1 wherein the radio-frequency radiation absorbing material is a composite material comprising a plurality of metal particles suspended in an resinous binder.

6. The radio frequency radiation suppressor of claim 2 wherein the inner sleeve comprises a tab member for holding the metallic connector in place.

7. The radio frequency radiation suppressor of claim 6 wherein the inner sleeve comprises a second tab member spaced from said tab member.

8. The radio frequency radiation suppressor of claim 7 wherein the inner sleeve further comprises a third tab member spaced from said tab member and said second tab member.

9. The radio frequency radiation suppressor of claim 2 wherein the inner sleeve has a recess for receiving the metallic connector said recess being formed and dimensioned such that the metallic connector is prevented from contacting the outer shell.

10. The radio frequency radiation suppressor of claim 1 further comprising an outer sleeve assembled to the exterior of the outer shell, said outer sleeve being formed of an electrical insulating material.

11. A method of making a radio frequency radiation suppressor for an industrial magnetron comprising the steps of:
forming an inner sleeve from an electrically insulating polymer material; and
forming a radio-frequency radiation absorbing outer shell on the inner sleeve.

12. The method set forth in claim 11 wherein the step of forming the radio-frequency radiation absorbing outer shell on the inner sleeve comprises the steps of:
placing a mold around the inner sleeve such that an annular spaced is formed around the exterior of the inner sleeve;
filling the annular space with a mixture of an iron-powder-containing resin and an activator/hardener;
curing the mixture until it hardens; and then
removing the mold.

13. The method set forth in claim 11 wherein the step of forming the inner sleeve comprises machining the electrically insulating polymer material.

14. The method set forth in claim 11 wherein the step of forming the inner sleeve comprises molding the electrically insulating polymer material.

15. The method set forth in claim 11 wherein the step of forming the inner sleeve comprises the step of forming the inner sleeve from polytetrafluoroethylene.

16. A radio frequency radiation suppressor for a magnetron, comprising
a) an inner sleeve member made of an electrical insulating polymer material;
b) an outer shell assembled to said inner sleeve member, said outer shell member being made of a material that absorbs radio-frequency radiation; and
c) a metallic connector attached to the inner sleeve member for contacting the magnetron.

17. The radio frequency radiation suppressor of claim 16 wherein said inner sleeve has a recess for receiving said metallic connector and is shaped such that said metallic connector does not contact said outer shell.

18. The radio frequency radiation suppressor of claim 17 wherein the electrical insulating polymer material is polytetrafluoroethylene.

19. The radio frequency radiation suppressor of claim 16 wherein the radio-frequency radiation absorbing material is a composite material comprising a plurality of metal particles suspended in an epoxy binder.

20. The radio frequency radiation suppressor of claim 16 further comprising an outer sleeve assembled to the exterior of the outer shell, said outer sleeve being formed of the electrical insulating polymer material.
